(19) United States
(12) Patent Application Publication
(10) Pub. No.: US 2024/0383598 A1
(43) Pub. Date: Nov. 21, 2024

(54) AIRCRAFT FAIRING HAVING A REMOVABLE PANEL AND A COMPRESSIBLE SEAL, AIRCRAFT HAVING AT LEAST ONE SUCH FAIRING

(71) Applicant: Airbus Operations SAS, TOULOUSE (FR)

(72) Inventors: Jean-Guillaume QUARANTA, TOULOUSE (FR); William BRAS, TOULOUSE (FR); Emy VINCON, TOULOUSE (FR); Mathieu SENTENAC, TOULOUSE (FR)

(21) Appl. No.: 18/666,960

(22) Filed: May 17, 2024

(30) Foreign Application Priority Data
May 19, 2023 (FR) 2304965

(51) Int. Cl. B64C 7/02; B64D 29/06

(52) U.S. Cl. CPC B64C 7/02; B64D 29/06

(57) ABSTRACT

An aircraft fairing having at least one structure, at least one fairing panel, at least one fastening element connecting the fairing panel and the structure, and at least one compressible seal interposed between first and second bearing zones that are as one, respectively, with the fairing panel and with the structure. The fairing panel comprises at least one rigid stop positioned in the first bearing zone, the stop and the compressible seal being configured such that the compression ratio of the compressible seal is less than or equal to 90%.

### CROSS-REFERENCES TO RELATED APPLICATIONS

This application claims the benefit of the French patent application No. 2304965 filed on May 19, 2023, the entire disclosures of which are incorporated herein by way of reference.

### FIELD OF THE INVENTION

The present application relates to an aircraft fairing having a removable panel and a compressible seal, and to an aircraft having at least one such fairing.

According to one embodiment, an aircraft pylon comprises a secondary structure and a plurality of fairing panels supported by the secondary structure. These various fairing panels have to be arranged so as to obtain a substantially sealed fairing.

### BACKGROUND OF THE INVENTION

Given the vagaries in the manufacture and assembly of the secondary structure and the fairing panels, gaps may remain between the panels or between the panels and the secondary structure after assembly. These gaps have to be filled.

According to a first operating mode, a sealing method comprises a step of applying strips of sealing mastic to the panel using a mask, a step of removing the mask, a step of polymerization so as to cure the sealing mastic and obtain a cured seal, then a step of mounting the panel. According to this first operating mode, the panel is removable and the cured seal is regular. However, this first operating mode is not satisfactory since it is time-consuming and the cured seal does not systematically fill the gap to be filled.

According to a second operating mode, a sealing method comprises a step of applying a sealing mastic to the secondary structure, the panel being removed, a step of mounting the panel equipped with a mold release agent, a step of removing the accessible surplus sealing mastic from the outside, then a step of polymerization so as to cure the sealing mastic and obtain a cured seal. Next, the sealing method comprises a step of removing the panel, a step of removing the surplus sealing mastic from the inside, a step of verifying the compliance of the cured seal obtained after the polymerization step and a step of remounting the panel. According to this second embodiment, the panel is removable and the cured seal perfectly conforms to the gap to be filled. However, this second operating mode is not satisfactory since it is time-consuming and the shape of the cured seal is not regular. Furthermore, if the cured seal is not compliant, it is necessary to clean the secondary structure and restart the method. Finally, if the panel has to be changed, the cured seal is not necessarily suited to the new panel.

According to a third embodiment, the sealing method comprises a step of applying sealing mastic to the secondary structure, a step of mounting the panel before curing of the sealing mastic, a step of removing the surplus sealing mastic from the outside, then a step of polymerization so as to cure the sealing mastic and obtain a cured seal. According to this third embodiment, the cured seal perfectly conforms to the gap to be filled. However, this third operating mode is not satisfactory since it is time-consuming and the panel is not removable without damaging the seal.

For the three operating modes, the sealing method is time-consuming on account of the time necessary for the preparation and polymerization of the sealing mastic. According to another drawback, the seal obtained following the polymerization of the sealing mastic has a certain stiffness that does not make it possible to absorb any dimensional variations in the gap on account of vibrational and aerodynamic phenomena.

The present invention aims to remedy all or some of the drawbacks of the prior art.

### SUMMARY OF THE INVENTION

To this end, the invention relates to an aircraft fairing having at least one structure, at least one fairing panel and at least one fastening element connecting the fairing panel and the structure, the fairing panel having an inner face oriented towards the structure, a peripheral edge and at least one first bearing zone situated on the inner face and running along the peripheral edge, the structure having at least one second bearing zone facing the first bearing zone, the aircraft fairing having at least one seal supported by the fairing panel and positioned between the first and second bearing zones.

According to the invention, the fairing panel comprises at least one rigid stop positioned in the first bearing zone. In addition, the seal is a compressible seal having a compression ratio, the stop and the compressible seal being configured such that the compression ratio of the compressible seal is less than or equal to 90%.

In operation, the compressible seal is never fully compressed on account of the presence of the stop, and this makes it possible to ensure sealing between the fairing panel and the structure.

According to another feature, the stop and the compressible seal are configured such that the compression ratio of the compressible seal is between 10 and 85%.

According to another feature, the stop is an overthickness that projects with respect to the inner face of the fairing panel.

According to another feature, the overthickness and the fairing panel form just a single piece.

According to another feature, the overthickness has a free face facing the structure, extends between outer and inner edges situated on either side of the fastening elements and comprises at least one groove, recessed with respect to the free face, configured to partially house the compressible seal.

According to one embodiment, the aircraft fairing comprises a plurality of fastening elements and a discontinuous compressible seal having a plurality of segments interposed between the fastening elements, the overthickness comprising one groove for each segment.

According to another embodiment, the aircraft fairing comprises a plurality of fastening elements and at least one continuous compressible seal having first, rectilinear or polygonal segments, interposed between the fastening elements, and second, curved segments, in the form of an arc of a circle, connecting the first segments by passing around the fastening elements.

According to another feature, the aircraft fairing comprises first and second continuous compressible seals, the first segments of the first compressible seal being parallel to and spaced apart from the first segments of the second compressible seal, the second, curved segments of the first compressible seal passing around the fastening elements on a first side, the second, curved segments of the second compressible seal passing around the fastening elements on a second side.

According to another embodiment, the aircraft fairing comprises a plurality of fastening elements and a continuous compressible seal having at least one rectilinear or polygonal segment situated between the fastening elements and the outer or inner edge of the overthickness.

According to another embodiment, the compressible seal adjoins the overthickness.

According to another feature, the fairing panel comprises at least one connection by adhesive bonding connecting the compressible seal and the overthickness or the fairing panel.

According to another feature, the aircraft fairing comprises at least one groove configured to partially house the compressible seal, the groove and the compressible seal being configured such that the compressible seal is compressed in the groove in order to obtain retention by compression of the compressible seal in the groove.

### BRIEF DESCRIPTION OF THE DRAWINGS

The invention also relates to an aircraft comprising at least one aircraft fairing according to one of the preceding features.

Further features and advantages will become apparent from the following description of the invention, which description is given solely by way of example, with reference to the appended drawings in which:

FIG. 1 is a side view of an aircraft,

FIG. 2 is a side view of an aircraft pylon,

FIG. 3 is a front view of an aircraft fairing panel without overthickness,

FIG. 4 is a front view of an aircraft fairing panel comprising an overthickness, before the mounting of a compressible seal, illustrating one embodiment of the invention,

FIGS. 5A, 5B and 5C depict transverse cross sections of an overthickness provided with a groove, illustrating various embodiments of the invention,

FIG. 6 is a transverse cross section of a structure and of a fairing panel equipped with an overthickness and with a compressible seal, before the mounting of the panel, illustrating one embodiment of the invention,

FIG. 7 is a transverse cross section of the structure and of the fairing panel that are visible in FIG. 6, after the mounting of the panel,

FIG. 8 is a longitudinal cross section along the line VIII-VIII in FIG. 7 of the structure and of the fairing panel,

FIG. 9 is a transverse cross section of a structure and of a fairing panel equipped with an overthickness and with a compressible seal, illustrating another embodiment of the invention,

FIG. 10 is a front view of a fairing panel comprising an overthickness and a compressible seal, illustrating one embodiment of the invention,

FIG. 11A depicts a front view of a part of a fairing panel comprising an overthickness and a compressible seal, illustrating another embodiment of the invention, and FIG. 11B depicts a cross section along the line B-B of the fairing panel visible in FIG. 11A and of a structure,

FIG. 12A depicts a front view of a part of a fairing panel comprising an overthickness and a compressible seal, illustrating another embodiment of the invention, and FIG. 12B depicts a cross section along the line B-B of the fairing panel visible in FIG. 12A and of a structure,

FIG. 13A depicts a front view of a part of a fairing panel comprising an overthickness and a compressible seal, illustrating another embodiment of the invention, and FIG. 13B depicts a cross section along the line B-B of the fairing panel visible in FIG. 13A and of a structure,

FIG. 14A depicts a front view of a part of a fairing panel comprising an overthickness and a compressible seal, illustrating another embodiment of the invention, and FIG. 14B depicts a cross section along the line B-B of the fairing panel visible in FIG. 14A and of a structure,

FIG. 15 is a transverse cross section of a structure and of a fairing panel comprising an overthickness and a compressible seal, illustrating one embodiment of the invention,

FIG. 16 is a transverse cross section of a structure and of a fairing panel comprising an overthickness and a compressible seal, illustrating another embodiment of the invention.

### DETAILED DESCRIPTION OF THE PREFERRED EMBODIMENTS

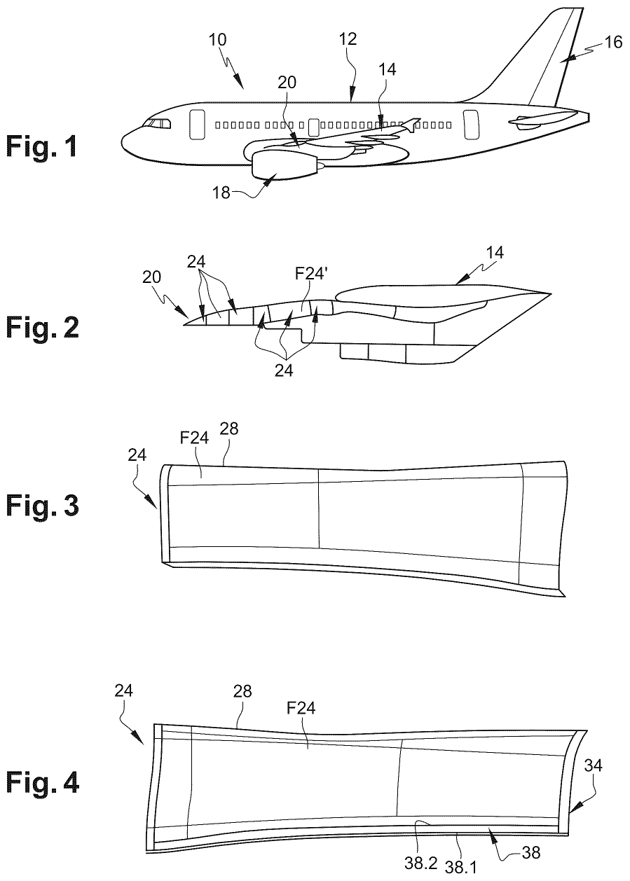

As illustrated in FIG. 1, an aircraft 10 comprises a fuselage 12, wings 14, an empennage 16, propulsion assemblies 18 and pylons 20, each pylon connecting one of the propulsion assemblies 18 to one of the wings 14. Each of these elements has an aerodynamic fairing.

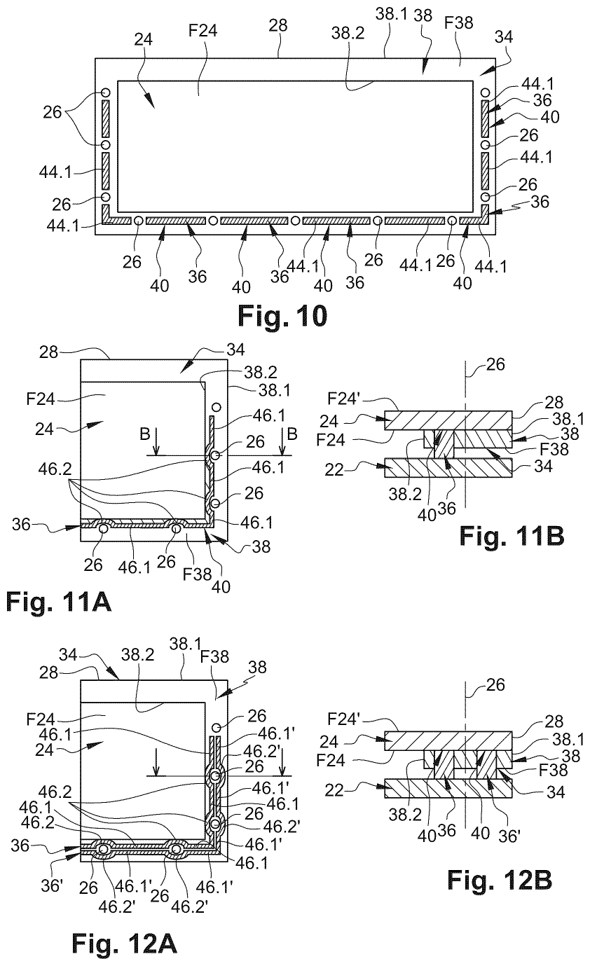

As illustrated in FIG. 2, each pylon 20 comprises at least one structure 22 (visible in FIGS. 6 to 8 and 11 to 16) and a plurality of fairing panels 24 arranged so as to form the aerodynamic fairing of the pylon 20 and each connected to the structure 22 by at least one fastening element 26 (FIG. 10). The same applies to the fuselage, the wings 14, the empennage 16 and the propulsion assemblies 18.

Whatever the embodiment, an aircraft fairing comprises at least one structure 22, at least one fairing panel 24 and at least one fastening element 26 (visible in FIG. 7) connecting the fairing panel 24 and the structure 22.

As illustrated in FIGS. 6 to 16, the fairing panel 24 has an inner face F24 oriented towards the structure 22 and an outer face F24′ opposite the inner face F24. According to one configuration, the fairing panel 24 is in the form of a more or less thick wall, such as a metal sheet or a plate made of composite material for example. For each fastening element 26, the fairing panel 24 comprises a passage hole that can be chamfered at its end opening at the outer face F24′.

According to one configuration, the fairing panel 24 is removable and connected to the structure 22 by at least one removable fastening element 26, such as a screw or a bolt for example.

As illustrated in FIGS. 3 and 6, the fairing panel 24 comprises at least one peripheral edge 28. According to one arrangement, the fairing panel 24 comprises a peripheral edge 28 that is polygonal, rectangular for example. The fairing panel 24 comprises, at its inner face F24, at least one first bearing zone 30 oriented towards the structure 22, running along the peripheral edge 28, which extends from the peripheral edge 28 over a given width (dimension taken in a direction perpendicular to the peripheral edge 28).

In addition, the structure 22 comprises at least one second bearing zone 32 facing the first bearing zone 30. Generally, the structure 22 comprises one second bearing zone 32 for each first bearing zone 30 of the fairing panel 24.

According to an arrangement visible in FIGS. 10 to 14B, the fastening elements 26 are positioned at the first and second bearing zones 30, 32.

The aircraft fairing comprises at least one seal interposed between the structure 22 and the fairing panel 24, more particularly between the first and second bearing zones 30, 32, the seal being in contact with the structure 22 and the fairing panel 24.

The fairing panel 24 comprises at least one rigid stop 34 positioned in at least one first bearing zone 30. In addition, the seal is a compressible seal 36 and comprises a part that projects with respect to the stop 34, in a direction perpendicular to the inner face F24 of the fairing panel 24, when the compressible seal 36 is not compressed.

Whatever the embodiment, the compressible seal 36 is supported by the fairing panel 24 and has elasticity in the manner of an element made of solid foam. According to one embodiment, the compressible seal 36 is a semi-finished product that does not require polymerization, and this makes it possible to obtain a significant time saving for the method for sealing the panels of the fairing. The fact that it is compressible allows the seal 36 to adapt to various configurations and to fill various gaps. Since the compressible seal 36 is supported by the fairing panel 24 and not by the structure 22, putting the seal in place does not impede the progress of the production of the structure 22.

The compressible seal 36 has a compression ratio varying from 0, when the compressible seal 36 is not compressed, to 100% of its operational range when the compressible seal 36 is fully compressed and cannot be compressed further.

The stop 34 and the compressible seal 36 are configured such that the compression ratio of the compressible seal 36 is less than or equal to 90%. In operation, even if the gap between the fairing panel 24 and the structure 22 varies on account of vibrational and aerodynamic phenomena, the compressible seal 36 is never fully compressed on account of the presence of the rigid stop 34, and this makes it possible to not damage the compressible seal 36 and to ensure sealing between the fairing panel 24 and the structure 22. Ideally, the stop 34 and the compressible seal 36 are configured such that the compression ratio of the compressible seal 36 is between 10 and 85% and preferably of the order of 80%.

As illustrated in FIG. 8, the distance between the first bearing zone 30 of the fairing panel 24 and the second bearing zone 32 of the structure 22 is not necessarily constant along the compressible seal 36. Consequently, the compressible seal 36 may have a compression ratio that varies along its length.

Depending on the circumstances, the compressible seal 36 extends continuously over the entire peripheral edge 28 of the fairing panel 24. As a variant, the compressible seal 36 extends continuously over a part of the peripheral edge 28, as illustrated in FIGS. 11A to 14B, or discontinuously over a part of the peripheral edge 28 of the fairing panel 24, as illustrated in FIG. 11A. Whatever the embodiment, the compressible seal 36 extends along at least a part of the peripheral edge 28.

According to an embodiment visible in FIG. 9, the fairing panel 24 comprises at least one groove 37 that is recessed with respect to the inner face F24 of the fairing panel 24 in which the compressible seal 36 is partly positioned, the latter projecting with respect to the inner face F24 that forms the stop 34. According to one arrangement, the groove 37 is substantially parallel to the peripheral edge 28. According to this embodiment, the compressible seal 36 is retained by any means in the groove 37.

According to other embodiments, which are visible in FIGS. 6, 7 and 10 to 16, the stop 34 is an overthickness 38 that projects with respect to the inner face F24 of the fairing panel 24.

According to one embodiment, the overthickness 38 is an element distinct from the fairing panel 24, such as a strip of material attached to the inner face F24 of the fairing panel 24, for example. According to another embodiment, the overthickness 38 and the fairing panel 24 form just a single piece. According to the latter embodiment, when the fairing panel 24 is made of composite material, it comprises a greater number of plies of fibers in line with the overthickness 38 than outside the overthickness 38. Of course, the invention is not limited to this embodiment for obtaining an overthickness 38 integrated in the fairing panel 24.

As illustrated in FIG. 4, the overthickness 38 extends continuously all along the peripheral edge 28 of the fairing panel 24. An a variant, the overthickness 38 extends discontinuously along a part of the peripheral edge 28 of the fairing panel 24. Thus, the fairing panel 24 may comprise at least one continuous or discontinuous overthickness 38 that extends along at least a part of the peripheral edge 28.

According to one configuration, each overthickness 38 extends between an outer edge 38.1, which is situated in line with the peripheral edge 28, and a second, inner edge 38.2, the outer and inner edges 38.1, 38.2 being situated on either side of the fastening elements 26. The overthickness 38 extends over the entire width of the first bearing zone 30 of the fairing panel 24.

According to one embodiment, the compressible seal 36 has a width less than or equal to one third of the width of the overthickness 38.

According to an arrangement visible in FIGS. 14A and 14B, the compressible seal 36 adjoins the overthickness 38. According to one variant, the compressible seal 36 is interposed between the peripheral edge 28 and the overthickness 38. According to another variant, the overthickness 38 is interposed between the peripheral edge 28 and the compressible seal 36.

According to this arrangement, the compressible seal 36 is connected to the inner face F24 of the fairing panel 24 by a connection such as a connection by adhesive bonding or a connection by screwing, for example.

In parallel, the second bearing zone 32 of the structure 22 is of sufficient width to be in contact with the stop 34 and the compressible seal 36.

According to other embodiments, which are visible in FIGS. 6 to 18, 10 and 16, the overthickness 38 has a free face F38 facing the structure 22, which is substantially parallel to the inner face F24 of the fairing panel 24 and distant from the latter. The overthickness 38 comprises at least one groove 40, recessed with respect to the free face F38, configured to partially house the compressible seal 36.

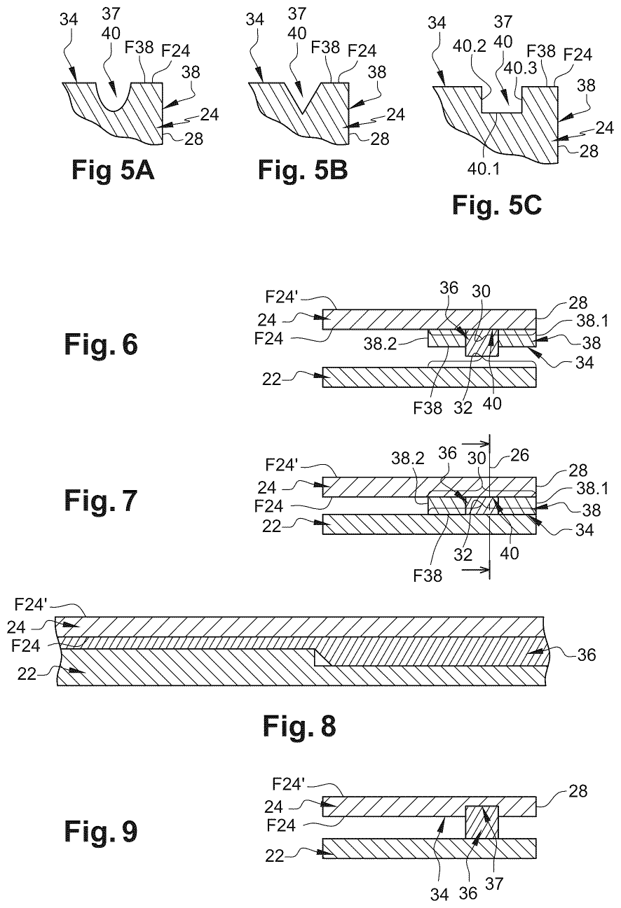

Whether it is made in the fairing panel 24 without overthickness or in the overthickness 38, the groove 37, 40 may have various transverse sections, as illustrated in FIG. 5. Thus, the groove 40 may have a U-shaped transverse section, as illustrated FIG. 5A, a V-shaped transverse section, as illustrated in FIG. 5B, or a square or rectangular transverse section, as illustrated in FIG. 5C. Of course, the invention is not limited to these transverse sections.

According to the embodiment visible in FIG. 5C, the groove 37, 40 has a bottom 40.1 that is distant from the free face F38 of the overthickness 38 or the inner face F24 of the fairing panel 24, and first and second edge faces 40.2, 40.3 that connect the bottom 40.1 and the free face F38 of the overthickness 38 or the inner face F24 of the fairing panel 24.

The groove 37, 40 has a depth (distance between the bottom 40.1 and the free face F38 of the overthickness 38 or the inner face F24 of the fairing panel 24) configured such that the compression ratio of the compressible seal 36 is between 10 and 85% and preferably of the order of 80%.

According to an embodiment visible in FIG. 15, the compressible seal 36 and the groove 40 are configured such that the compressible seal 36 is compressed in the groove 40, more particularly between the first and second edge faces 40.2, 40.3 of the groove 40. This arrangement makes it possible to obtain retention by compression of the compressible seal 36 in the groove 40. This solution can also be applied when the groove 37 is recessed with respect to the inner face F24 of the fairing panel 24 and the latter does not comprise an overthickness, as illustrated in FIG. 9.

According to another embodiment, which is visible in FIG. 16, the fairing panel 24 comprises at least one connection by adhesive bonding 42 connecting the compressible seal 36 and the overthickness 38. According to one configuration, the connection by adhesive bonding 42 is positioned between the compressible seal 36 and the bottom 40.1 of the groove 40.

According to an embodiment visible in FIG. 10, the fairing panel 24 comprises a discontinuous compressible seal 36 having a plurality of segments 44.1 interposed between the fastening elements 26. In addition, the fairing panel 24 comprises one groove 40 for each segment 44.1. According to this embodiment, the grooves 40 and the segments 44.1 of the compressible seal 36 are rectilinear or polygonal and each have a simple geometry.

According to embodiments visible in FIGS. 11A and 12A, the fairing panel 24 comprises at least one continuous compressible seal 36 having first, rectilinear or polygonal segments 46.1 interposed between the fastening elements 26 and second, curved segments 46.2, in the form of an arc of a circle, connecting the first segments 46.1 by passing around the fastening elements 26, said second segments 46.2 being situated between the fastening elements 26 and the outer or inner edge 38.1, 38.2 of the overthickness 38.

According to the embodiment visible in FIG. 11A, the fairing panel 24 comprises a single continuous compressible seal 36 of which the second, curved segments 46.2 are situated between the fastening elements 26 and the inner edge 38.2 of the overthickness 38.

According to the embodiment visible in FIG. 12A, the fairing panel 24 comprises first and second continuous compressible seals 36, 36′, the first segments 46.1 of the first compressible seal 36 being parallel to and spaced apart from the first segments 46.1′ of the second compressible seal 36′, the second, curved segments 46.2 of the first compressible seal 36 passing around the fastening elements 26 on a first side situated between the fastening elements 26 and the inner edge 38.2 of the overthickness 38, the second, curved segments 46.2′ of the second compressible seal 36′ passing around the fastening elements 26 on a second side situated between the fastening elements 26 and the outer edge 38.1 of the overthickness 38.

Unlike the embodiment visible in FIG. 10 and according to the embodiments visible in FIGS. 11A and 12A, the grooves are more complex to produce. In addition, the overthickness 38 and the second bearing zone 32 of the structure 22 are wider.

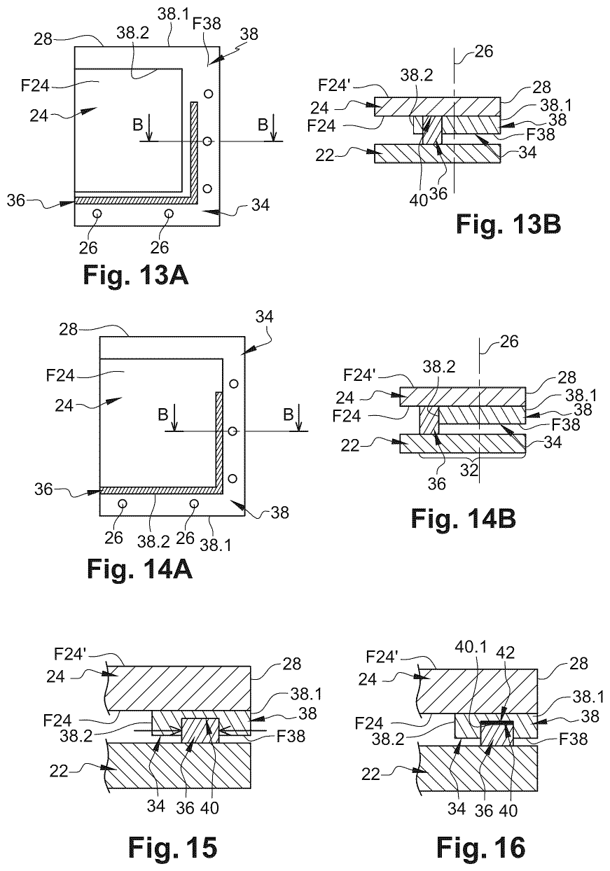

According to an embodiment visible in FIGS. 13A and 13B, the fairing panel 24 comprises a single continuous compressible seal 36 having at least one rectilinear or polygonal segment situated between the fastening elements 26 and the outer or inner edge 38.1, 38.2 of the overthickness 34. In addition, the overthickness 38 has a groove 40 that has at least one rectilinear segment, parallel to the outer or inner edge 38.1, 38.2 of the overthickness 38, situated between the fastening elements 26 and the outer or inner edge 38.1, 38.2 of the overthickness 34. According to this embodiment, the groove 40 comprises only rectilinear or polygonal segments, and this tends to simplify its production. The overthickness 38 and the second bearing zone 32 of the structure 22 are wider than according to the embodiment visible in FIG. 10.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft fairing comprising:
at least one structure,
at least one fairing panel,
at least one fastening element connecting the fairing panel and the structure,
the fairing panel having an inner face oriented towards the structure, a peripheral edge and at least one first bearing zone situated on the inner face and running along the peripheral edge,
the structure having at least one second bearing zone facing the first bearing zone, and
at least one seal supported by the fairing panel and positioned between the first and second bearing zones,
wherein the fairing panel comprises at least one rigid stop positioned in the first bearing zone and,
wherein the seal is a compressible seal having a compression ratio,
the stop and the compressible seal being configured such that the compression ratio of the compressible seal is less than or equal to 90%.

2. The aircraft fairing according to claim 1, wherein the stop and the compressible seal are configured such that the compression ratio of the compressible seal is between 10 and 85%.

3. The aircraft fairing according to claim 1, wherein the stop is an overthickness that projects with respect to the inner face of the fairing panel.

4. The aircraft fairing according to claim 3, wherein the overthickness and the fairing panel form just a single piece.

5. The aircraft fairing according to claim 3, wherein the overthickness has a free face facing the structure, extends between outer and inner edges situated on either side of the fastening elements and comprises at least one groove, recessed with respect to the free face, configured to partially house the compressible seal.

6. The aircraft fairing according to claim 5, wherein the at least one fastening element comprises a plurality of fastening elements, and wherein the aircraft fairing comprises a plurality of fastening elements and a discontinuous compressible seal having a plurality of segments interposed between the fastening elements, the overthickness comprising one groove for each segment.

7. The aircraft fairing according to claim 5, wherein the at least one fastening element comprises a plurality of fastening elements, and wherein the aircraft fairing comprises a plurality of fastening elements and at least one continuous compressible seal having first, rectilinear or polygonal segments, interposed between the fastening elements, and second, curved segments, in the form of an arc of a circle, connecting the first segments by passing around the fastening elements.

8. The aircraft fairing according to claim 7, wherein the aircraft fairing comprises first and second continuous compressible seals, the first segments of the first compressible seal being parallel to and spaced apart from the first segments of the second compressible seal, the second, curved segments of the first compressible seal passing around the fastening elements on a first side, the second, curved segments of the second compressible seal passing around the fastening elements on a second side.

9. The aircraft fairing according to claim 5, wherein the aircraft fairing comprises a plurality of fastening elements and a continuous compressible seal having at least one rectilinear or polygonal segment situated between the fastening elements and the outer or inner edge of the overthickness.

10. The aircraft fairing according to claim 3, wherein the compressible seal adjoins the overthickness.

11. The aircraft fairing according to claim 3, wherein the fairing panel comprises at least one connection by adhesive bonding connecting the compressible seal and the overthickness of the fairing panel.

12. The aircraft fairing according to claim 1, wherein the aircraft fairing comprises at least one groove configured to partially house the compressible seal, the groove and the compressible seal being configured such that the compressible seal is compressed in the groove in order to obtain retention by compression of the compressible seal in the groove.

13. An aircraft comprising at least one aircraft fairing according to claim 1.
